(19) United States
(12) Patent Application Publication
(10) Pub. No.: US 2026/0241868 A1
(43) Pub. Date: Aug. 20, 2026

(54) Roof rack

(71) Applicant: Yanhua Chen, Zhongshan (CN)

(72) Inventor: Yanhua Chen, Zhongshan (CN)

(21) Appl. No.: 19/647,946

(22) Filed: Apr. 15, 2026

(51) Int. Cl. B60R 9/04

(52) U.S. Cl. CPC B60R 9/04

(57) ABSTRACT

A roof rack is provided, including: a bottom bracket for supporting a fixed bracket connected to a roof; two side brackets respectively perpendicularly arranged on two opposite side edges of the bottom bracket; a front bracket arranged on a front side edge of the bottom bracket; and a rear bracket arranged on a rear side edge of the bottom bracket. The front bracket and the rear bracket are configured to be rotatable respectively relative to the bottom bracket to be folded and abut against the bottom bracket. The roof rack has a simple structure and can achieve free selection and switching of a carrying space and enhance expansion functionality.

### TECHNICAL FIELD

The present disclosure relates to the technical field of automobile accessories, and more particularly to, a roof rack.

### BACKGROUND

With the development of the society, people pursue increasingly high quality of life. Vehicles not only meet daily transportation needs, but also serve as companions for journeys. Nowadays, more users drive to forests and beaches to get close to the nature and engage in activities such as camping, cycling, and surfing. Consequently, roof racks are used to carry outdoor expansion facilities. Currently, most roof racks have fixed load-bearing spaces after being mounted. They can only meet a relatively single requirement for carrying and fail to meet diverse carrying needs for different types of facilities.

### SUMMARY

In view of the above content, the present disclosure aims to at least solve one of the technical problems in the prior art. To this end, an embodiment of the present disclosure provides a roof rack. By arranging two fixed side brackets on two sides of a bottom bracket and movably arranging a front bracket and a rear bracket on a front side and a rear side respectively, a carrying space can achieve diverse switching between front and rear structures while maintaining stability in a left-right direction, and a receiving and expansion effect is good. The roof rack has a simple structure and is applicable to large-scale industrial production.

To this end, in a first aspect, an embodiment of the present disclosure provides a roof rack, including:

a bottom bracket for supporting and being connected to a fixed bracket of a roof;

two side brackets respectively perpendicularly arranged on two opposite side edges of the bottom bracket;

a front bracket arranged on a front side edge of the bottom bracket; and

a rear bracket arranged on a rear side edge of the bottom bracket.

The front bracket and the rear bracket are configured to be rotatable respectively relative to the bottom bracket to be folded and abut against the bottom bracket.

Preferably, a rotation range of the front bracket relative to the bottom bracket is 0° to 70°; and/or,

a rotation range of the rear bracket relative to the bottom bracket is 0° to 90°.

Preferably, the front bracket is separably connected to at least one of the side brackets in a locked manner, and the rear bracket is separably connected to at least one of the side brackets in a locked manner.

Preferably, the roof rack further includes a locking member. The locking member passes through the side brackets to lock the front bracket or the rear bracket.

Preferably, the locking member includes an operating portion located on outer sides of the side brackets, extending portion connected to the operating portion and passing through the side brackets, and a limiting portion located on inner sides of the side brackets and connected to the extending portion. An end of the extending portion correspondingly locks the front bracket or the rear bracket.

Preferably, the extending portion of the locking member is provided with a stud. The front bracket and the rear bracket are respectively correspondingly provided with locking fitting members with screw holes.

Preferably, the bottom bracket is configured as a combined rod bracket structure; and/or,

the side brackets are configured as combined rod bracket structures; and/or,

the rear bracket is configured as a combined rod bracket structure; and/or,

the front bracket is configured as a plate-like structure.

Preferably, the bottom bracket includes a plurality of transverse rods, a plurality of longitudinal rods, and a plurality of connecting sleeves. The connecting sleeves are provided with first receiving slots and second receiving slots that are perpendicular to each other, and are correspondingly arranged at intersections of the transverse rods and the longitudinal rods and sleeve and fix the transverse rods and the longitudinal rods.

Preferably, each side bracket includes a first connector, a second connector, a third connector, and a plurality of supporting rods. The first connector, the second connector, and the third connector are spaced apart from each other in sequence. The plurality of supporting rods are respectively detachably arranged between the first connector and the second connector and between the second connector and the third connector.

Preferably, the roof rack further includes a locking member and a locking fitting member. The locking member passes through the first connector or the third connector to lock the locking fitting member located on the front bracket or the rear bracket.

Preferably, the roof rack further includes an expansion connector for connecting the bottom bracket to the fixed bracket of the roof.

Preferably, the expansion connector includes a connecting rod, a connecting pressing block, a connecting gasket, and two connecting caps. The connecting rod is N-shaped and includes a middle section and two connecting sections which perpendicularly extend from two ends of the middle section. Two ends of the connecting pressing block are respectively sleeved to the two connecting sections. Two ends of the connecting gasket are respectively sleeved to the two connecting sections and are located on one side of the connecting pressing block away from the middle section. The two connecting caps are operably locked to ends of the two connecting sections respectively. A first mounting space is formed between the connecting pressing block and the middle section. A second mounting space is formed between the connecting pressing block and the connecting gasket. One of the first mounting space and the second mounting space is configured to receive and fix a part of structures of the bottom bracket, and the other one of the first mounting space and the second mounting space is configured to receive the fixed bracket of the roof.

According to the roof rack provided in the embodiments of the present disclosure, by arranging the two fixed side brackets on the two sides of the bottom bracket and movably arranging the front bracket and the rear bracket on the front side and the rear side respectively, a carrying space can achieve diverse switching between front and rear structures while maintaining stability in a left-right direction, thus forming a first carrying state in which the bottom bracket serves as a carrying main body and the two side brackets, the front bracket, and the rear bracket assist in carrying, and a second carrying state in which the bottom bracket serves as a carrying main body, the two side brackets assist in carrying, and the front and rear sides expand freely, so that the receiving and expansion effect is good. The roof rack has a simple structure and is favorable for implementing large-scale market production and application.

### BRIEF DESCRIPTION OF THE DRAWINGS

FIG. 1 is a schematic diagram of a three-dimensional structure of a roof rack in a first carrying state according to an embodiment of the present disclosure;

FIG. 2 is a schematic diagram of a three-dimensional structure of the roof rack in FIG. 1 in a second carrying state;

FIG. 3 is a schematic diagram of a three-dimensional structure of the roof rack in FIG. 1 including an expansion connector; and

FIG. 4 is a front view of the expansion connector in FIG. 3.

### DETAILED DESCRIPTION OF THE EMBODIMENTS

Detail description of the embodiments of present disclosure will be made in the following, and examples thereof are illustrated in the drawings, throughout which identical or similar elements or elements of identical or similar functions are represented with identical or similar reference numerals. The embodiments that are described with reference to the accompanying drawings are exemplary, and are only used to interpret the present disclosure, instead limiting the present disclosure.

The following disclosure provides many different embodiments or examples to implement different structures of the present disclosure. In order to simplify the disclosure of the present disclosure, components and settings of specific examples are described below. Certainly, they are merely examples and are not intended to limit the present disclosure. In addition, the present disclosure may repeatedly refer to numbers and/or letters in different examples. Such repetition is for purposes of simplicity and clarity and does not itself indicate a relationship between the various embodiments and/or settings discussed. In addition, the present disclosure provides examples of various specific processes and materials, but a person of ordinary skill in the art will recognize the application of other processes and/or the use of other materials.

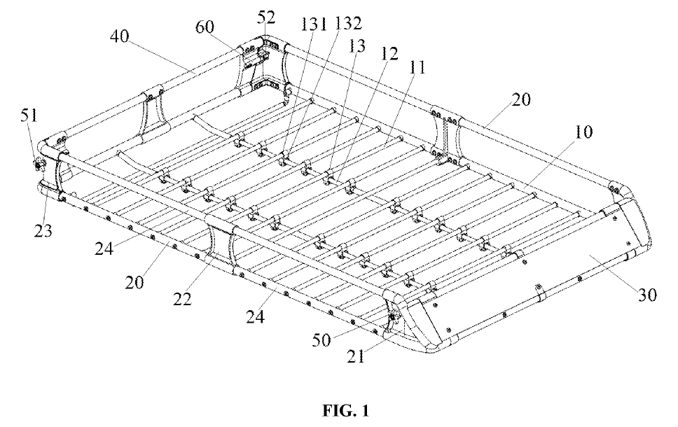

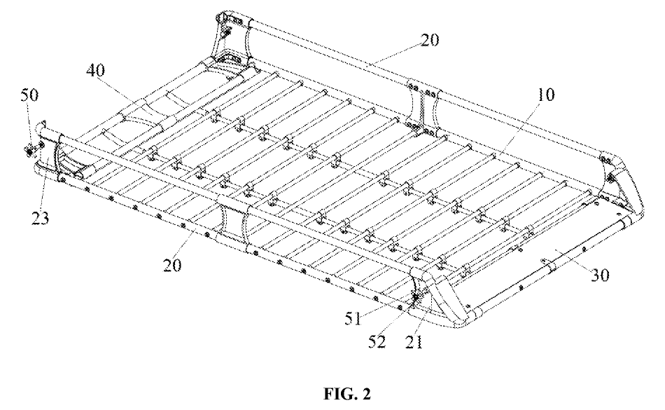

Referring to FIG. 1 and FIG. 2, the present disclosure aims to provide a roof rack which achieves a carrying function of a vehicle roof. The roof rack provided in the embodiments of the present disclosure can switch carrying states and achieve selection of different carrying spaces, to meet carrying requirements for different to-be-carried objects.

The roof rack specifically includes:

a bottom bracket 10 for supporting and being connected to a fixed bracket (not shown) of a roof;

two side brackets 20 respectively perpendicularly arranged on two opposite side edges of the bottom bracket 10;

a front bracket 30 arranged on a front side edge of the bottom bracket 10; and

a rear bracket 40 arranged on a rear side edge of the bottom bracket 10.

The front bracket 30 and the rear bracket 40 are configured to be rotatable respectively relative to the bottom bracket 10 to be folded and abut against the bottom bracket 10.

In this embodiment, the bottom bracket 10 serves as a main supporting structure of the roof rack. A lower part of the bottom bracket 10 is connected to the fixed bracket of the roof and an upper part is configured to carry various pieces of luggage or facilities. The two side brackets 20 are perpendicularly and fixedly disposed relative to the bottom bracket to form fixed limiting and supporting structures on the two sides to restrict a lateral position of luggage or facility. The front bracket 30 and the rear bracket 40 are configured to be movably connected to the bottom bracket 10, and can be respectively configured to be in either an upright or laid-down state. According to different usage requirements, the front bracket 30 and the rear bracket 40 are selectively not laid down, or one or two of them is or are laid down, thus achieving extension and switching of front and rear sides of a carrying space.

Further, a rotation range of the front bracket 30 relative to the bottom bracket 10 is 0° to 70°. In this embodiment, an angle between the front bracket 30 in the upright state and the bottom bracket 10 is approximately 70°, thus forming an inclined ramp on the front side of the front bracket 30. It can be understood that when luggage or facility is carried, the luggage or facility is also placed slantways to an extent. This inclined ramp or the inclined placement state of the luggage or facility can reduce wind resistance during vehicle operation, thus enhancing driving stability and ensuring safety.

Further, a rotation range of the rear bracket 40 relative to the bottom bracket 10 is 0° to 90°. In this embodiment, an angle between the rear bracket 40 in the upright state and the bottom bracket 10 is approximately 90°, which can maximize the carrying space and maintain carrying stability.

Further, the front bracket 30 is separably connected to at least one of the side brackets 20 in a locked manner, and the rear bracket 40 is separably connected to at least one of the side brackets 20 in a locked manner. In this embodiment, when the front bracket 30 and the rear bracket 40 are in the upright states, they are respectively connected to the side brackets 20 in the locked manner, thereby forming a stable combined structure. It can be understood that in other embodiments, positioning structures for the front bracket 30 and the rear bracket 40 are not limited to this, and can also be supporting structures connected to the bottom bracket 10 in a state-switching manner, such as foldable supporting corner beams, both ends of which are respectively connected between the bottom bracket 10 and the front bracket 30 or the rear bracket 40. When the supporting corner beam is in an unfolded state, the front bracket 30 or the rear bracket 40 is supported to stand upright, and when the positioning structure is in a folded state, the front bracket 30 or the rear bracket 40 is rotated to be laid down.

Further, the roof rack further includes a locking member 50. The locking member 50 passes through the side brackets 20 to lock the front bracket 30 or the rear bracket 40. In this embodiment, the side brackets 20 and the front bracket 30 or the rear bracket 40 are locked by the locking member 50, facilitating operations. It can be understood that a locking structure is not limited to this. It can also be a self-locking buckle structure. For example, the side brackets 20 and the front bracket 30 or the rear bracket 40 are respectively provided with male and female buckles which can be buckled with each other or detached from each other.

Further, the locking member 50 includes an operating portion 51 located on outer sides of the side brackets 20, extending portion 52 connected to the operating portion 51 and passing through the side brackets 20, and a limiting portion (not shown) located on inner sides of the side brackets 20 and connected to the extending portion 52. An end of the extending portion 52 correspondingly locks the front bracket 30 or the rear bracket 40. The locking member 50 in this embodiment is easily operated from the outer side. Rotating the operating portion 51 can drive the extending portion 52 to be locked into or detached from the front bracket 30 or the rear bracket 40. In addition, the limiting portion is configured to prevent the locking member 50 from being detached from the side brackets 20 when the front bracket 30 and the rear bracket 40 are not in the upright states, thus avoiding inconvenience caused by an additional storage requirement. It can be understood that the structure of the locking member 50 is also not limited to this. Other structures that can lock the side brackets 20 and the front bracket 30 or the rear bracket 40 are also possible. In addition, the locking member 50 is not limited to passing through the side brackets 20 and being locked to the front bracket 30 or the rear bracket 40. On the contrary, the locking member can also be disposed on the front bracket 30 and the rear bracket 40 and correspondingly locked to the side brackets 20.

Further, the extending portion 52 of the locking member 50 is provided with a stud. The front bracket 30 and the rear bracket 40 are respectively correspondingly provided with locking fitting members 60 with screw holes. In this embodiment, the locking member 50 is specifically in locking fit with the front bracket 30 or the rear bracket 40 through threaded fit.

Further, the bottom bracket 10 is provided with a combined rod bracket structure. The combined rod bracket structure is formed by arranging and combining a plurality of rod bodies, which helps weight reduction. It can be understood that the bottom bracket 10 can also be configured as a plate-like structure, for example, an aluminum alloy plate-like structure.

Further, the side brackets 20 are configured as combined rod bracket structures. In this implementation, the side brackets 20 can also be correspondingly formed by arranging and combining a plurality of rod bodies.

Further, the rear bracket 40 is configured as a combined rod bracket structure. In this implementation, the rear bracket 40 can also be correspondingly formed by arranging and combining a plurality of rod bodies.

Further, the front bracket 30 is configured as a plate-like structure. In this embodiment, the front bracket 30 is preferably configured as the plate-like structure. This can further reduce the wind resistance of the bracket during vehicle operation.

The bottom bracket 10 includes a plurality of transverse rods 11, a plurality of longitudinal rods 12, and a plurality of connecting sleeves 13. The connecting sleeves 13 are provided with first receiving slots 131 and second receiving slots 132 that are perpendicular to each other, and are correspondingly arranged at intersections of the transverse rods 11 and the longitudinal rods 12 and sleeve and fix the transverse rods 11 and the longitudinal rods 12. In this embodiment, the bottom bracket 10 is specifically formed by combining and splicing the transverse rods 11, longitudinal rods 12, and the connecting sleeves 13. Actually, the combined structure is detachably spliced, with a simple structure and ease of mounting and removal.

Further, each side bracket 20 includes a first connector 21, a second connector 22, a third connector 23, and a plurality of supporting rods 24. The first connector 21, the second connector 22,and the third connector 23 are spaced apart from each other in sequence. The plurality of supporting rods 24 are respectively detachably arranged between the first connector 21 and the second connector 22 and between the second connector 22 and the third connector 23. In this embodiment, each side bracket 20 is specifically spliced and combined by the connectors and the supporting rods. This also achieves effects of ease of mounting and removal and structural stability.

Further, in another embodiment, the roof rack includes a locking member 50 and a locking fitting member 60. The locking member 50 passes through the first connector 21 or the third connector 23 to lock the locking fitting member 60 located on the front bracket 30 or the rear bracket 40.

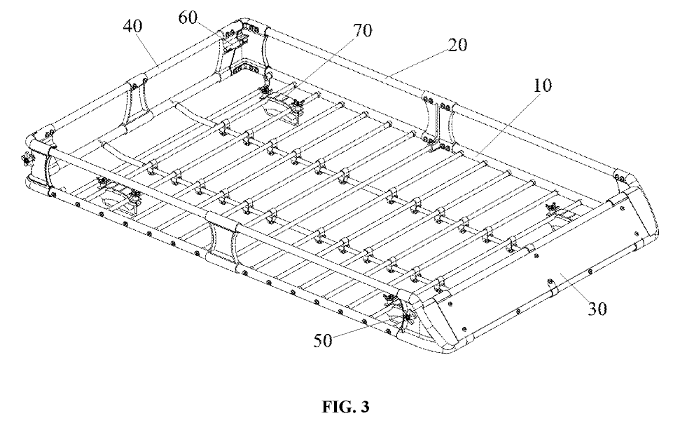

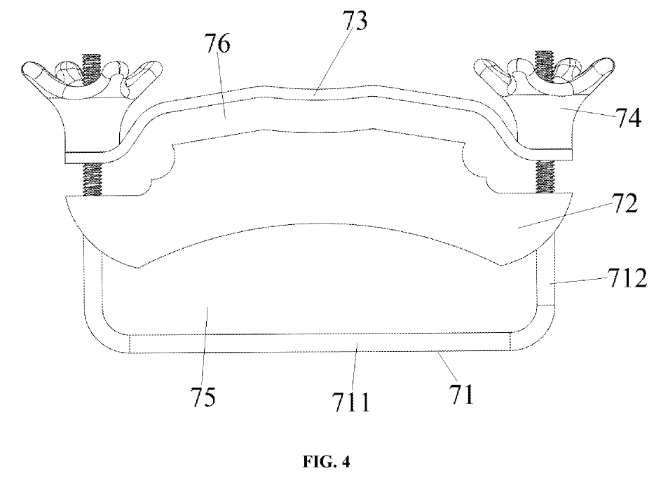

Further, referring to FIG. 3 and FIG. 4, the roof rack further includes an expansion connector 70 for connecting the bottom bracket 10 to the fixed bracket of the roof.

Specifically, the expansion connector 70 includes a connecting rod 71, a connecting pressing block 72, a connecting gasket 73, and two connecting caps 74. The connecting rod 71 is N-shaped and includes a middle section 711 and two connecting sections 712 which perpendicularly extend from two ends of the middle section 711. Two ends of the connecting pressing block 72 are respectively sleeved to the two connecting sections 712. Two ends of the connecting gasket 73 are respectively sleeved to the two connecting sections 712 and are located on one side of the connecting pressing block 72 away from the middle section 711. The two connecting caps 74 are operably locked to ends of the two connecting sections 712 respectively. A first mounting space 75 is formed between the connecting pressing block 72 and the middle section 711. A second mounting space 76 is formed between the connecting pressing block 72 and the connecting gasket 73. One of the first mounting space 75 and the second mounting space 76 is configured to receive and fix a part of structures of the bottom bracket 10, and the other one of the first mounting space 75 and the second mounting space 76 is configured to receive the fixed bracket of the roof. In this embodiment, according to the specific structure of the expansion connector 70, two mounting manners can be selectively selected. One manner is that the connecting caps 74 are located on an upper side. This facilitates mounting and removal by a user. In this manner, the first mounting space 75 is configured to receive the fixed bracket of the roof, and the second mounting space 76 is configured to receive a part of the structures of the bottom bracket 10, preferably a rod body structure of the bottom bracket 10. In another mounting manner, the connecting caps 74 are arranged on a lower side of the bottom bracket 10. In this way, the first mounting space 75 is configured to receive a part of the structures of the bottom bracket 10, preferably a rod body structure of the bottom bracket 10, and the second mounting space 76 receives the fixed bracket of the roof. In this way, the expansion connector 70 occupies a small space of the carrying space of the roof rack and does not cause an adverse effect on the luggage or facility carried.

It can be understood that in the foregoing embodiments, one bottom bracket 10, two side brackets 20, one front bracket 30, and one rear bracket 40 are provided. In addition, four pairs of locking members 50 and locking fitting members 60 are preferably provided, which respectively symmetrically lock the front bracket 30 and the rear bracket 40 from the two sides. Four expansion connectors 70 are preferably provided, and usually two fixed brackets on the vehicle are provided. The four expansion connectors 70 are divided into two groups and are connected to the fixed brackets, so that the structure is stable and reliable.

According to the roof rack provided in the embodiments of the present disclosure, by arranging the two fixed side brackets 20 on the two sides of the bottom bracket 10 and movably arranging the front bracket 30 and the rear bracket 40 on the front side and the rear side respectively, a carrying space can achieve diverse switching between front and rear structures while maintaining stability in a left-right direction, thus forming a first carrying state in which the bottom bracket 10 serves as a carrying main body and the two side brackets 20, the front bracket 30, and the rear bracket 40 assist in carrying, and a second carrying state in which the bottom bracket 10 serves as a carrying main body, the two side brackets 20 assist in carrying, and the front and rear sides expand freely, so that the receiving and expansion effect is good. The roof rack has a simple structure and is favorable for implementing large-scale market production and application.

In the description of this specification, the description referring to the terms "one embodiment", "some embodiments", "an example", "specific examples", "some examples", or the like means that specific features, structures, materials or characteristics described in connection with the embodiments or examples are included in at least one embodiment or example of the present disclosure. In this specification, the schematic representations of the above terms are not necessarily intended to refer to the same embodiment or example. Furthermore, the specific features, structures, materials or characteristics described may be combined in any suitable manner in any one or more embodiments or examples. In addition, those skilled in the art may combine the different embodiments or examples described in this specification, as well as the features of different embodiments or examples, without mutual contradictions.

Although the embodiments of the present disclosure have been shown and described, it can be understood by those of ordinary skill in the art that various changes, modifications, substitutions variations can be made to these embodiments without departing from the principle and concept of the present disclosure. The scope of the present disclosure is defined by the claims and their equivalents.

What is claimed is:

1. A roof rack, comprising:
a bottom bracket for supporting and being connected to a fixed bracket of a roof;
two side brackets respectively perpendicularly arranged on two opposite side edges of the bottom bracket;
a front bracket arranged on a front side edge of the bottom bracket; and
a rear bracket arranged on a rear side edge of the bottom bracket,
wherein the front bracket and the rear bracket are configured to be rotatable respectively relative to the bottom bracket to be folded and abut against the bottom bracket.

2. The roof rack according to claim 1, wherein a rotation range of the front bracket relative to the bottom bracket is 0° to 70°; and/or,
a rotation range of the rear bracket relative to the bottom bracket is 0° to 90°.

3. The roof rack according to claim 1, wherein the front bracket is separably connected to at least one of the side brackets in a locked manner, and the rear bracket is separably connected to at least one of the side brackets in a locked manner.

4. The roof rack according to claim 3, further comprising a locking member, wherein the locking member passes through the side brackets to lock the front bracket or the rear bracket.

5. The roof rack according to claim 4, wherein the locking member comprises an operating portion located on outer sides of the side brackets, extending portion connected to the operating portion and passing through the side brackets, and a limiting portion located on inner sides of the side brackets and connected to the extending portion; and an end of the extending portion correspondingly locks the front bracket or the rear bracket.

6. The roof rack according to claim 5, wherein the extending portion of the locking member is provided with a stud; and the front bracket and the rear bracket are respectively correspondingly provided with locking fitting members with screw holes.

7. The roof rack according to claim 1, wherein the bottom bracket is configured as a combined rod bracket structure; and/or,
the side brackets are configured as combined rod bracket structures; and/or,
the rear bracket is configured as a combined rod bracket structure; and/or,
the front bracket is configured as a plate-like structure.

8. The roof rack according to claim 7, wherein the bottom bracket comprises a plurality of transverse rods, a plurality of longitudinal rods, and a plurality of connecting sleeves; and the connecting sleeves are provided with first receiving slots and second receiving slots that are perpendicular to each other, and are correspondingly arranged at intersections of the transverse rods and the longitudinal rods and sleeve and fix the transverse rods and the longitudinal rods.

9. The roof rack according to claim 7, wherein each side bracket comprises a first connector, a second connector, a third connector, and a plurality of supporting rods; the first connector, the second connector, and the third connector are spaced apart from each other in sequence; and the plurality of supporting rods are respectively detachably arranged between the first connector and the second connector and between the second connector and the third connector.

10. The roof rack according to claim 9, further comprising a locking member and a locking fitting member, wherein the locking member passes through the first connector or the third connector to lock the locking fitting member located on the front bracket or the rear bracket.

11. The roof rack according to claim 1, further comprising an expansion connector for connecting the bottom bracket to the fixed bracket of the roof.

12. The roof rack according to claim 11, wherein the expansion connector comprises a connecting rod, a connecting pressing block, a connecting gasket, and two connecting caps; the connecting rod is N-shaped and comprises a middle section and two connecting sections which perpendicularly extend from two ends of the middle section; two ends of the connecting pressing block are respectively sleeved to the two connecting sections; two ends of the connecting gasket are respectively sleeved to the two connecting sections and are located on one side of the connecting pressing block away from the middle section; the two connecting caps are operably locked to ends of the two connecting sections respectively; a
first mounting space is formed between the connecting pressing block and the middle section; a second mounting space is formed between the connecting pressing block and the connecting gasket; one of the first mounting space and the second mounting space is configured to receive and fix a part of structures of the bottom bracket, and the other one of the first mounting space and the second mounting space is configured to receive the fixed bracket of the roof.
